(19) United States
(12) Patent Application Publication
(10) Pub. No.: US 2005/0213748 A1
(43) Pub. Date: Sep. 29, 2005

(54) Line extender for high speed modem data transfer

(75) Inventors: Kent Messerschmidt, Randers (DK); Morten Laursen, Noerresundby (DK); Jorgen Dalby-Jakobsen, Svenstrup (DK); Jacob Florian Randbaek, Aalborg (DK)

Correspondence Address: FOLEY AND LARDNER;SUITE 500, 3000 K STREET NW, WASHINGTON, DC, 20007, US

(73) Assignee: RTX Telecom A/S

(21) Appl. No.: 11/055,714

(22) Filed: Feb. 11, 2005

Related U.S. Application Data
(60) Provisional application No. 60/543,282, filed on Feb. 11, 2004.

(51) Int. Cl. H04M 9/08

(52) U.S. Cl. 379/406.08; 379/406.01

(57) ABSTRACT

A first aspect provides an echo canceller suitable for such as modem-modem communication systems, such as in a Telephone Line Extender system, either with a wireless or wire-borne communication. The echo canceller comprising adaptive filter means for receiving a first signal and for providing a filter output signal at least partly in response to the first signal, delay means in a signal path of a second signal in order to provide a delay output signal, and summation means for adding the filter output signal and the delay output signal in order to prepare the second signal for digital transmission. Another aspect of the invention provides a Telephone Line Extender system comprising a portable part (PP), or extension unit, for connection to a modem, and a fixed part (FP), or base unit, for connection to an analog telephone plug, these PP and FP parts comprising means for exchange of data, such as wireless means, these exchange of data means comprising an echo canceller as described above. The TLE system comprises modem cheating means adapted to manipulate signals in a negotiation with the modem, preferably A and B signals in phase 2 of e.g. a V.34 negotiation. In still another aspect provides a settop box comprising a TLE system as described.

### FIELD OF THE INVENTION

The invention relates to the field of Telephone Line Extenders (TLEs). More specifically, the invention relates to TLEs for modem data transfer, such as V.34, V.90 or V.92 modem signals, at high modem speeds. The invention provides an echo canceller and a method for controlling an echo canceller. In addition, the invention relates to a Digital Signal Processor (DSP) system, a DSP executable algorithm, and a data frame structure. Still further, the invention relates to a signal processing circuit, a TLE system, a TLE product and a pay-per-view settop box.

### BACKGROUND OF THE INVENTION

Modem-modem communication, or modem-telefax communication, comprises an analog modem connected to a Public Switched Telephone Network (PSTN) network for data transfer. For example pay-per-view cable TV and satellite TV have settop boxes that often use analog modems connected to Public Switched Telephone Network (PSTN) network for data transfer between a user and a service provider. Most often the settop box is wire connected to the PSTN network. However, in order to eliminate the wire connection between the settop box and the PSTN network a wireless connection may be desirable. In order for a pay-per-view system transaction system to function properly, a highly reliable connection is required, i.e. data corruption must be eliminated. In case of errors important data relating to validation of a user account etc. may be corrupted. Thus, demands to a communication link in such a pay-per-view system is quite strict. In addition, the modem speed required in such systems is normally 14.4 kbit/s or even higher.

If a wireless TLE system is desired, one possible solution for a wireless connection between a pay-per-view settop box and the PSTN network is to use standard DECT lines. However, using DECT lines with 8 kHz sampling frequency and a resolution of 8 bit a/u-law coding or 14 bit linear coding, modem signal speeds beyond 9.6 kbit/s can not be transferred reliably.

Thus, there is a need for technical solutions suitable for a Telephone Line Extender (TLE) system providing a wireless connection capable of achieving a reliable connection also at higher data transfer rates, such as with a modem speed of at least 14.4 kbit/s.

### SUMMARY OF THE INVENTION

In a first aspect the invention provides a method of processing a first and a second signal in an echo canceller, the method comprising the steps of:
providing the first signal to adaptive filter means of the echo canceller and generate a filter output signal at least partly in response to said first signal,
providing the second signal to delay means so as to generate a delay output signal, and
adding the filter output signal and the delay output signal in order to prepare the second signal for digital transmission.

Preferably said digital transmission is a wireless digital transmission, however it may be a wired digital transmission.

Preferably the method further comprises the step of updating filter coefficients of the adaptive filter means. Preferably the method further comprises the step of deciding upon update of filter coefficients of the adaptive filter means in response to a detected frequency bandwidth of the first signal. Said step of deciding upon filter coefficient update may further comprises calculating a first level of the first signal and a second level of the second signal. Said step of deciding upon filter coefficients update may comprise detecting a level of the second delayed output signal and detecting a level of the added filter output signal and the delay output signal. Said step of updating filter coefficients may comprise calculating a filter update factor in response to a detected level of the first signal.

In a second aspect the invention provides a DSP executable algorithm adapted to perform the method according to the first aspect.

In a third aspect the invention provides a DSP system adapted to execute the algorithm according to the second aspect.

In a fourth aspect the invention provides an echo canceller for processing a first and a second signal, the echo canceller comprising
adaptive filter means for receiving the first signal and for providing a filter output signal at least partly in response to said received first signal,
delay means in a signal path of the second signal, said delay means providing a delay output signal, and
summation means for adding the filter output signal and the delay output signal in order to prepare the second signal for digital transmission.

In preferred embodiments, the digital transmission is a wireless digital transmission, however it may be a wired digital transmission.

Preferably the echo canceller further comprises decision means for deciding upon update of filter coefficients of the adaptive filter. The adaptive filter means preferably comprises a FIR filter. The adaptive filter means may comprise means for updating filter coefficients in response to an LMS error signal. The adaptive filter means may comprise detector means for detecting that part of the first signal comprising information for updating filter coefficients. The detector means may comprise a double-talk detector. A double-talk detection threshold of said double-talk detector may be controlled by dynamic control means. Said dynamic control means may comprise means for controlling the double-talk detection threshold in response to a predetermined size of an LMS error signal.

The echo canceller may further comprising means for calculating a first level of the first signal and a second level of the second signal. The decision means may be adapted to decide upon filter update in response to a ratio between said first and second levels.

The echo canceller may further comprise a wide-band signal filter adapted to filter the first signal and to provide the wide-band signal filtered first signal to the decision means so as to allow filter coefficient update upon the wide-band signal filtered first signal exceeding a predetermined level.

The echo canceller may further comprise means for calculating a filter update factor in response to a level of the first signal.

The echo canceller may further comprise a ratio control unit adapted to calculate a difference between a level of the delay output signal and a level of the output signal from the summation means and to provide said difference to the decision means.

In preferred embodiments the echo canceller is implemented in a Digital Signal Processor (DSP).

In a fifth aspect the invention provides a signal processing circuit comprising
a codec part adapted for connection to an associated analog modem,
an echo canceller according to any of claims the fourth aspect, and
a digital interface adapted for transmission of digital signals.

In preferred embodiments, the digital interface is a digital air-interface adapted for wireless transmission of digital signals, however the digital interface may be a wired-interface adapted for wired transmission of digital signals.

Preferably the echo canceller receives signals from the codec part, and provide signals to the digital interface for digital transmission. Preferably the codec part is adapted to receive signals transmitted to the digital interface from said digital interface.

The connection to the associated analog modem may be formed by a 2-wire connection.

In embodiments comprising an air-interface, such air-interface preferably operates according to a DECT standard or derivatives thereof, or other types of systems based on digital communication, such as Bluetooth, Zig-bee, HomeRF or WLAN (802.11) .

In a sixth aspect the invention provides a signal processing circuit comprising an echo canceller inserted in a transmission path, the echo canceller comprising adaptive filter means being purely operable to those specific parts of incoming modem signals intended for use in controlling said echo canceller in order to prepare said incoming modem signals for digital transmission. Preferably the digital transmission is wireless, however it may be a wired digital transmission.

In a seventh aspect the invention provides a data frame structure comprising two double slots, wherein each double slot comprises a standard DECT double slot, the DECT double slot having a B-field format comprising
a header field,
a header field protection field,
a data field,
a data field protection field, and
a FEC field

In a preferred embodiment the data frame structure comprises three double slots. The three double slots may comprise first and second double slots for data and a third double slot for repetition of one of the first and second double slots. In another preferred embodiment the data frame structure comprises four double slots. The four double slots may comprise first and second data double slots and first and second double slots being repeated versions of the first and second data double slots.

The header field protection field and the data field protection field may be CRCs. Said CRCs may be standard DECT R-CRCs.

The FEC field may be a 32 bit ReedSolomon (100,96). Alternatively the FEC field has a length larger than 32 bit.

The data field may have a length of at least 200 bit. Preferably the data field has a length of 720 bit.

In an eighth aspect the invention provides a Telephone Line Extender system adapted for connection of an associated modem to an associated analog telephone plug, the system comprising
a Portable Part adapted for connection to an the associated modem, and
a Fixed Part adapted for connection to an the analog telephone plug, wherein the Portable Part and the Fixed Part comprise means for exchange of data, and wherein said means comprise an echo canceller according to any of claims the fourth aspect.

The terms Fixed Part and Portable Part should be construed as declaratory terms only without any limiting effect. Other terms used in connection with TLEs are: Base Unit and Extension Unit, respectively. The Fixed Part may be fixed or stationary, while the Portable Part may be portable or non-stationary, however it may be chosen differently.

The exchange of data may comprise a data frame structure according to the seventh aspect. Codec parts of the Portable Part and the Fixed Part may be adapted to operate at a sample frequency of at least 8 kHz, such as at least 10 kHz.

The associated modem may be an analog modem or a digital modem.

The Telephone Line Extender System may further comprise modem cheating means adapted to manipulate signals in a negotiation with the associated modem. The modem cheating means serves to cheat or manipulate the associated modem to adjust its echo canceller in a different way than it would do by merely estimating a round-trip delay. The round-trip delay being defined as a time lapsed from a signal is sent from a first modem to a second modem and returned to the first modem. The modem cheating means serves to emulate a different value for the round-trip delay in order to substantially compensate for the presence of the TLE system itself in the communication path between a near-end and a far-end modem. The modem cheating means is preferably adapted to manipulate signals in phase 2 of the negotiation with the associated modem. The modem cheating means is preferably adapted to manipulate at least one of signals A and B with respect to their timing.

In one embodiment the Telephone Line Extender System transmits an inverted version of signal B a predetermined period after an inversion of signal A is present at the Fixed Part. This embodiment is adapted for operation in phase 2 of the V.34 protocol. Preferably, the predetermined period is within the interval 10-100 ms, preferably within 20-60 ms, more preferably within 30-50 ms, such as 40 ms.

In another embodiment prepared for V.90 operation, the Telephone Line Extender System transmits an inverted version of signal A a predetermined period after an inversion of signal B is present at the Fixed Part. This embodiment is adapted for operation in phase 2 of the V.34 protocol. Preferably, the predetermined period is within the interval 10-100 ms, preferably within 20-60 ms, more preferably within 30-50 ms, such as 40 ms.

Preferably the Portable Part and the Fixed Part comprise means for wireless exchange of data. The Portable Part and the Fixed Part may alternatively comprise means for wireless exchange of data. In still another alternative, the Portable Part and the Fixed Part comprise means for wireless as well as wired exchange of data.

In a ninth aspect the invention provides a Telephone Line Extender product comprising a Portable Part integrated with a modem, wherein the Portable Part is adapted for digital communication with an associated Fixed Part connected to an analog telephone plug. The digital communication may be a wireless digital communication or a wired digital communication, or a combination thereof.

In a tenth aspect the invention provides a pay-per-view settop box comprising a Telephone Line Extender product according to the ninth aspect.

### BRIEF DESCRIPTION OF DRAWINGS

In the following the invention will be described in details with reference to the accompanying figures, of which

FIG. 1 shows a block diagram of an example of a TLE system adapted for wirelessly connecting a modem and an analog telephone plug,

FIG. 2 shows a block diagram of one part of the TLE adapted for interfacing an analog modem signal to a digital wireless signal,

FIG. 3 shows a block diagram of an echo canceller part of the TLE system,

FIG. 4 shows a preferred data format structure for use in the digital communication involved in the TLE system,

FIG. 5 shows a preferred data format of a B-field of a DECT compatible double slot,

FIG. 6 shows a preferred format of the B-field header of FIG. 5,

FIG. 7 shows a block diagram of one part of the TLE system where buffers have been added to both TX and RX signal paths,

FIG. 8 shows a block diagram of an audio signal path in a preferred wireless TLE system comprising in its Portable Part (Extension Unit) a noise generator,

FIG. 9 shows, for the TLE system of FIG. 8, an example of phases 1-3 of a communication scheme in case of using the V.34 protocol,

FIG. 10 shows an example of a modem cheating procedure implemented in phase 2 of the V.34 protocol.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

Even though the embodiments in the following communicate wirelessly, it should be understood that the general principles according to the invention are valid also within embodiments that communicate via a wired connection.

### DETAILED DESCRIPTION OF THE INVENTION

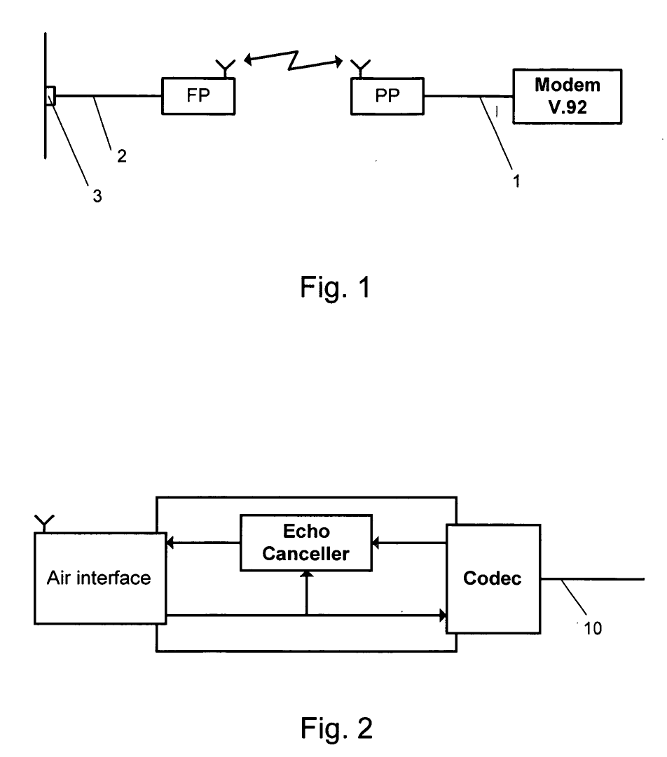

FIG. 1 shows a TLE system for wireless transfer of analog modem signals, such as for use in wireless connection of a pay-per-view settop box to the PSTN network. In FIG. 1 a V.92 type modem is connected by a standard 2-wire analog telephone connection 1 to a first wireless device, a portable part (PP) adapted for converting the analog modem signal to a digital wireless signal. A second wireless device, a fixed part (FP), is adapted to receive the digital wireless signal from the PP and to convert the received signal to an analog signal 2 and to provide this signal to the PSTN via an analog telephone plug 3.

FIG. 2 illustrates the principle of conversion from an analog modem signal 10 into a corresponding digital signal, which can be carried on a digital air-interface. In FIG. 2 the arrows indicate signal paths. The system is symmetric so the principles are valid for both the FP and PP parts even though illustrated for the PP part in FIG. 2. The signal transformation from analog to digital and from digital to analog, is done using a Codec running at a sampling frequency being at least 8 kHz. To achieve a higher transmission rate than with standard DECT formats the analog bandwidth of the Codec part must be above the standard 3.4 kHz, hence demanding a higher sampling frequency. A sampling frequency of 9 kHz provides adequate performance, but 10.3 kHz may be preferred. The resolution of the digital samples is preferably at least 14 bit linear, more preferably 16 bit linear. However, preferably the digital resolution is at level with standard digital telephone signals, namely 8 bit a/u-law coded or 14 bit linear coded. Still, a fair performance can still be achieved when decreasing the resolution by one or two bits. Using 12 bit resolution it is possible to obtain at least 14.4 kbit/s.

By introducing a digital signal path between two analog signals adds a delay. Using an air-interface based transmission, as in this case, adds to the delay and makes it too large for the echo cancellers of the connected modems to handle. This problem is solved by introducing digital echo cancellers where 2-line analog signals are converted to digital signals or viceversa. The echo canceller is preferably implemented on digital signal processor (DSP) parts of the PP and the FP. As illustrated by the arrows in FIG. 2 only one signal path is interfered by the echo canceller. However, the echo canceller utilises both signal paths for the echo cancellation process.

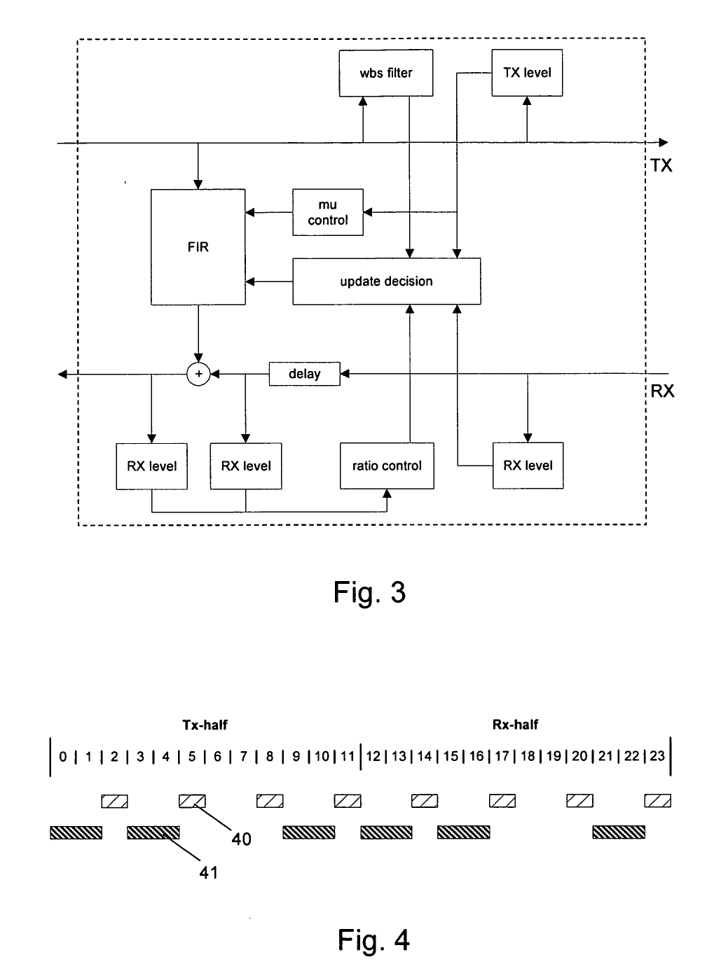

FIG. 3 illustrates the principles of a preferred echo canceller according to the invention. As seen in FIG. 3 the transmission signal path (TX) passes through the echo canceller, whereas the receiver (RX) signal path is delayed and added to an output of a an adaptive filter. The adaptive filter is implemented as a Finite Impulse Response (FIR) filter. An adaptive Least Mean Square (LMS) algorithm is used for controlling update of the FIR filter coefficients. A LMS error signal is used as part of the filter update process.

In order for the echo canceller to function properly with modem signals the echo canceller FIR filter only adapts to those specific parts of the modem signals intended for adjusting echo cancellers in the transmission path. These specific signals are broad bandwidth signals, such as white noise, transmitted only one way at a time. According to the invention these specific signals are detected by the echo canceller by using double-talk detectors and a wide band signal (wbs) filter. Using the wbs filter it is possible to detect for the presence of high frequency content of the TX signal and thus providing an indication of the presence of the specific echo canceller signals. A double-talk detection threshold is reduced dynamically with a size of the LMS error signal. The size of the LMS error signal is derived from comparing input and output of a LMS FIR filter summation point when no double-talk is present. As this error signal becomes smaller the double-talk decision threshold is reduced, and hereby the receive-to-transmit signal ratio of the echo canceller must be smaller to allow update of the FIR filter. This secures the FIR filter from loosing its correctly adapted coefficients by wrong update decisions.

In FIG. 3 the transmission (TX) signal passes through the unit unchanged. Still the TX signal is used for 1) signal input to the echo canceller FIR filter, 2) signal input to a wide-band-signal (wbs) filter, and for 3) TX signal level detection. The TX signal level is also used for scaling the FIR filter update factor, mu. This is so as to obtain the best possible performance from the echo canceller.

The receiving (RX) signal is processed by a short delay and by a summation point of the echo canceller. The summation point adds the delayed RX signal and an output signal from the FIR filter. The RX signal is also used as input to three different signal level detectors. A first RX signal level detector is positioned in the signal path before the delay, a second RX signal level detector is positioned between the delay and summation point, and a third RX signal level detector is positioned in the signal path after the summation point.

A ratio between RX and TX signal levels is used as Input for a decision of whether the FIR filter coefficients can be updated or not. The actual value of the RX/TX ratio is calculated by a ratio control unit, based on the difference between RX signal levels before and after the summation point.

In addition to the echo cancelling principles described, a successful implementation requires fast signal detectors and careful trimming of parameters and levels.

FIG. 4 illustrates a preferred frame structure, where the connection is in normal condition using 3 double slots to support the required bandwidth. In FIG. 4 RF setup 40 and modem connection 41 are illustrated.

The digital air-interface is designed to support the bandwidth generated by the Codec when using a sampling rate of 10.3 kHz, i.e. 164.6 kbit/s. This bandwidth is achieved by using 3 double slots in each DECT frame, leaving a single slot for bearer handover and support of outgoing handset calls. To allow an implementation that does not require a zero-blindslot radio only slots 0, 3, 6 and 9 are supported by the FP.

The DECT air interface implementation must provide the system with an error free channel to avoid destroying performance of the modem, and support the bit-rate generated by the digital signal-processing unit. Errors in a digital channel occur as either bit errors or frame errors. To avoid bit errors all data is protected by CRC, and optionally with a Forward Error Correcting (FEC) code which will enable a receiver part to correct a number of bit errors.

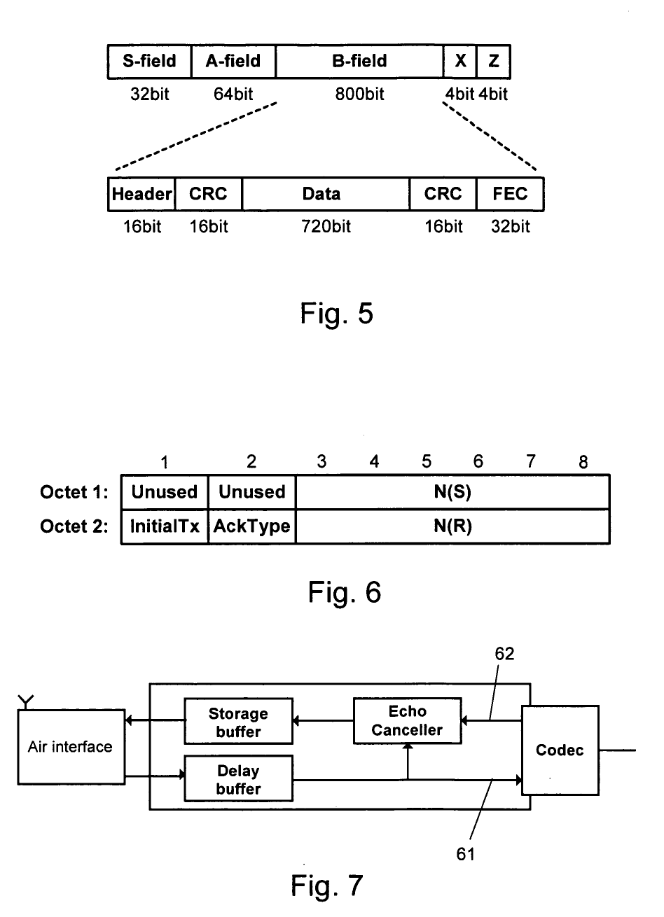

FIG. 5 illustrates a preferred data format using double slots. These are standard DECT double slot as specified in EN 300 175-2, with a dedicated B-field format. The S-, A-, X-and Z-fields are standard DECT implementations, as specified in EN 300 175-3.

A preferred B-field includes a 16 bit header field that is protected by a 16 bit CRC, and a 720 bit data field protected by both a 16 bit CRC and a 32 bit FEC code.

The 16 bit CRCs serving to protect the header and the data part of the B-field packet is using a standard DECT R-CRC as specified in EN 300 175-3, section 6.2.5.2 using the generating polynomial:
g(x) =x¹⁶+x¹⁰+x⁸+x⁷+x³+1

The 32 bit FEC field is a ReedSolomon (100,96) based on the primitive polynomial:
p(x) =x⁸+x⁴+x³+x²+1
and the generator polynomial:
g(x) =x⁴+α⁷⁶x³+α²⁵⁰x²+α⁷⁹x¹ +α⁷

Connection setup and release is using an Advanced A-field setup procedure for a multi-bearer connection as specified in the EN 300 175-3, and Encryption activation follow the standard multi-bearer encryption activation procedure.

A size of the FEC field is preferably selected according to the amount of signal processing power available for the DSP implementation. If possible with respect to the chosen chipset, the FEC field size is preferably larger than 32 bit.

Frame errors are minimized using a semi-dualslot diversity and an ARQ mechanism, which allows the system to retransmit lost frames. The B-field data field results in a connection bandwidth of 3×72 kbit/s=216 kbits/s. The additional bandwidth compared to the system requirement of 164.6 kbit/s, is used for ARQ implementation to allow for retransmission in case of errors in the air transfer.

FIG. 6 shows a preferred format of the B-field header. To optimize the air-interface utilization all data is sent in 90 byte packets over the air-interface, and the N(S) field contains the sequence number of packet. AckType indicates a type of the N(R) field, which can be either SACK (Selective Acknowledgement) or ACK (Cumulative Acknowledgement), with the following coding: SACK: 1, and ACK: 0. ACK type indicates to the transmitter that all frames up to the value in N(R) have been received. SACK is used to acknowledge single packets, which occur when errors are present in the sequence of data. InitialTx bit is set when a packet with a specific sequence number is transmitted initially. Unused fields are set to zero.

FIG. 7 sketches a solution enabling support of retransmission. A delay buffer is implemented in the RX signal path 61, and a storage buffer is implemented in the TX signal path 62. The delay buffer is delaying the forwarding of data from the air-interface towards the DSP, and the storage buffer is used as data storage in case retransmission is required. A preferred buffer size is 100 ms for the storage buffer as well as for the delay buffer.

In the following preferred principles for data packet handling in reception is described. When a packet is received the FEC decoding is applied, and afterwards the header and data CRC fields are evaluated. If the header CRC is incorrect the packet is discarded, but if the header CRC is correct the data is stored in the RX buffer with the position determined by the N(S) value. If the data CRC is correct and all packets before the N(S) value contained in the packet have been received an updated ACK is transmitted. If the data sequence contains holes due to errors, a SACK is transmitted with the N(R) value set to the N(S) value just received.

When the receiver can determine that it is no longer possible to receive a packet in time to place it in the delay buffer, it shall acknowledge the packet by updating the cumulative Ack value and transmit this new value in N(R) field in the next ACK.

In the following preferred principles for data packet handling in transmission is described. Three types of transmissions are defined: Initial transmission, Retransmission and Idle transmission. The priority order between the transmission types is: 1) Retransmission, 2) Initial transmission, and 3) Idle transmission.

An Idle transmission is a retransmission of the last transmitted packet, and such Idle transmission only occurs if no new packet is available in the storage buffer in the TX signal path (see FIG. 7). The following rules apply for retransmissions:
A) Do not retransmit a packet on the same bearer as the last transmission of the specific packet
B) Do not initiate a new retransmit until the reply should have been received

An effect of the echo cancelling principles and the data format and data transmission schemes described is that it is possible to establish a wireless transmission which is more robust to interference to avoid bit errors. In addition, it is possible to obtain wireless transfer of analog modem signal with a data rate higher than what is possible by usage of standard DECT technology. Hereby the principles described are suitable for applications such as TV pay-per-view or a number of other applications requiring wireless transfer of classified data at a data transfer speed higher than provided by standard DECT technology.

The air-interface could optionally be based on 2.4 GHz (5.8 GHz) fast frequency hopping technique instead of DECT 1.9 GHz dynamic channel allocation. The air-interface may in principle be based on any suitable wireless technology.

The FP and PP can be configured to operate with different transmission power levels to optimise tradeoffs between range and interference into other equipment, such as a settop box of a pay-per-view system. Optionally, a transmission power level may be controlled by a manual switch or alternatively it may be controlled automatically.

A standard DECT handset may be registered to the FP. When this handset sets up a connection to the FP, the air-interface is switched to standard DECT audio format using 32 kbit/s ADPCM based on 8 kHz sample rate. It may be implemented so that the handset connection has priority over modem connection.

If preferred, the PP may be integrated with the modem. In case of a pay-per-view system the PP could be integrated with the settop box. In case two or more settop boxes are used in one household, a communication link between the settop boxes may be established.

A TLE system according to the principles described is capable of providing reliable transfer of modem signal at speeds exceeding 33.6 kbit/s.

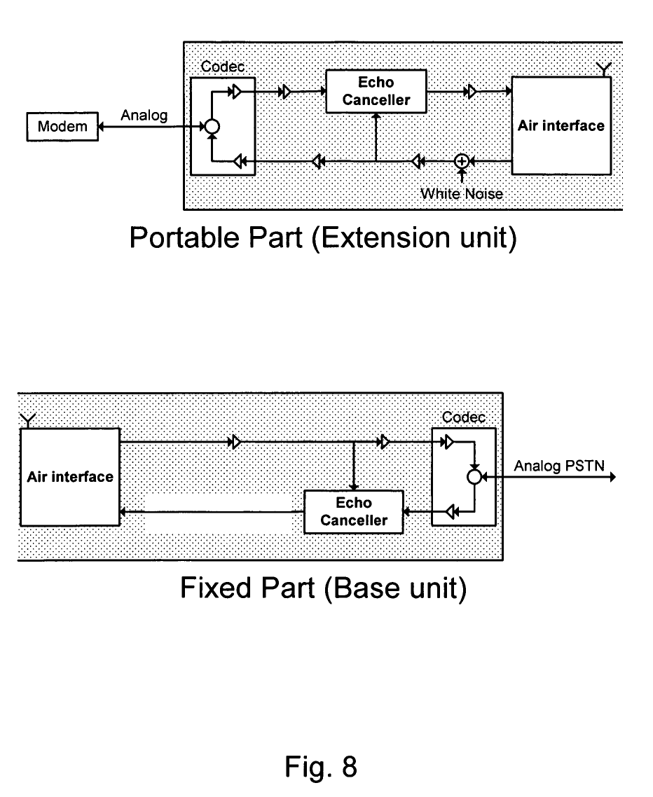

FIG. 8 shows diagrams of audio signal paths in a Portable Part or Extension Unit (PP) and a Fixed Part or Base Unit (FP) of a preferred TLE system adapted to transfer analog PSTN signals from V32bis, V.34 and V.90/92 modems. The PP and FP both comprise an air-interface adapted to handle their inter-communication. However, if preferred, the PP and FP may be inter-connected using a wired interface.

The FP is connected to a PSTN line, such as a wall plug, and the PP is connected to a modem. Both the FP and the PP comprise a 16 bit linear codec, an Echo canceller and an Air-interface part. For some applications it may be desired that the FP comprises in addition a suppressor. The PP comprises a noise generator, preferably adapted to generate substantially white noise. In a preferred embodiment, the codec is running at 9 kHz, limited by air-interface bandwidth, with a 16 bit resolution.

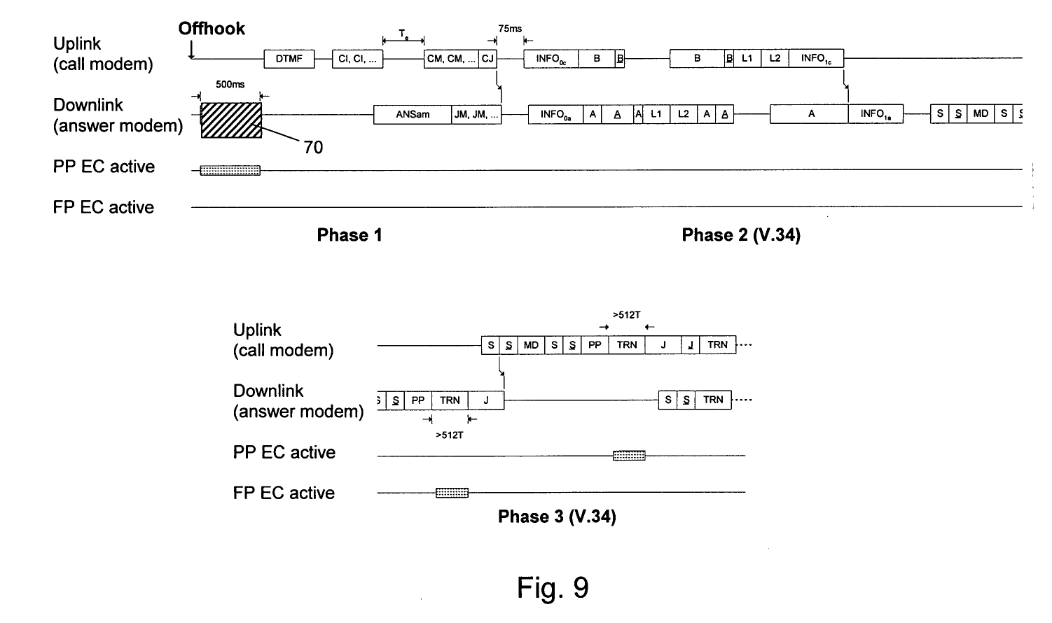

FIG. 9 illustrates, for the TLE embodiment of FIG. 8, phases 1-3 of a communication scheme. Phase 1 starts with “Offhook”, i.e. the modem goes off-hook, and phases 2 and 3 are illustrated for an example where the V.34 protocol is used. “PP EC active” illustrates periods where the echo canceller in the PP is active, “FP EC active” illustrates periods where the echo canceller in the FP is active.

Signals A, B and their inverted versions A and B, according to the standards, are:
A: 2400 Hz tone+1800 Hz guard tone
A: 2400 Hz tone (phase reversed, i.e. with its phase shifted 180 degrees)+1800 Hz guard tone
B: 1200 Hz tone
B: 1200 Hz tone (phase reversed, i.e. with its phase shifted 180 degrees)

The echo cancellers in the system are only activated when white noise is detected, and are only running when the TRN signal is present during phase 3. In order to avoid echos looping in the system, the noise generator of the PP is used to generate a noise signal 70, preferably the noise signal 70 after the modem goes off-hook. Preferably the noise signal 70 comprises white noise and has a duration in the range 100-1000 ms, preferably in the range 300-700 ms, more preferably in the range 400-600 ms, most preferably 500 ms. Hereby, the echo canceller in the PP is pre-trained. The audio coming from the network (downlink audio) is opened after the noise signal 70, and if the modem is doing dial tone detect before dialling, the dialling will be delayed with the same time as the duration of the noise signal 70, i.e. such as 500 ms.

The modem in the head-end of the system uses a round-trip delay estimate measured during phase 2 of the modem (V.34 & V.90/92) negotiation to locate its echo canceller in the time domain. However, having introduced the TLE system in the communication path between first and second modems, either with a wireless or with a wired connection between the PP and the FP, the round-trip delay observed by the modem is no longer a valid measure of the echo location. This is due to the fact that the TLE system itself introduces an additional delay and due to the fact that the echo canceller in the PP removes echo from the modem. Thus, there is a need for a method of “cheating” the modem to adjust its echo canceller so as to compensate for the presence of the TLE system.

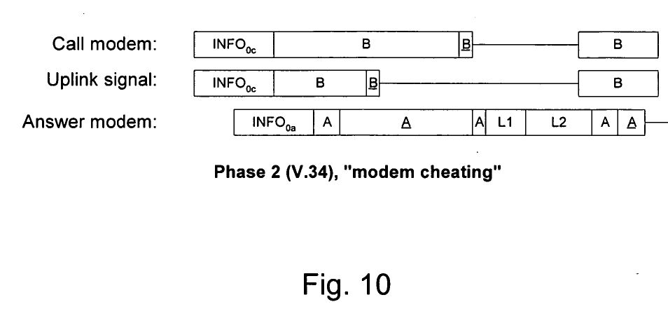

FIG. 10 shows an example of phase 2 of a V.34 communication in which the TLE system manipulates signals in order to “cheat” the modem to adjust its echo canceller so as to compensate for the presence of the TLE system. A, B, A and B are as indicated above. To cheat the head-end modem into locating its echo canceller in the correct position in the time domain, the TLE manipulates the B signals in phase 2 of the negotiation in order to “adjust” the round-trip delay estimate performed by the modem that consequently locates its echo canceller in response to the “adjusted” round-trip delay estimate.

In FIG. 10 the uplink signal is the signal sent by the FP. The cheating comprises manipulation of A and B signals in phase 2 of the negotiation. In case of V.34 mode, such as shown in FIG. 10, the cheating comprises inverting the B signal a predetermined period after the A signal inversion is present on the line, or is present in the FP. In the preferred embodiment, this predetermined period is 40 ms. In case of V.90 mode, the cheating comprises inverting the A signal when B signal inversion is present on the line, or is present in the FP.

The preferred embodiment illustrated in FIGS. 8-10 is implemented without a delay buffer, i.e. it does not provide ARQ retransmission. The reason is that the described modem cheating scheme does only operate properly in case of a system delay of less than approximately 50 ms. Preferably, the system delay is less than 40 ms. The reason is that round-trip delay is used to adjust timeout values in addition to echo canceller adjustment. Thus, if the modem is cheated to adjust its round-trip estimate to be much smaller than the actual delay, a timeout error will occur.

In case of a larger system delay, such as a system delay of 100 ms or more, modem cheating can not be applied. Thus, a poor uplink speed will result. However, by not applying modem cheating, ARQ retransmission can be applied, and thus an improved air-interface performance can be obtained.

1. An echo canceller for processing a first and a second signal, the echo canceller comprising
an adaptive filter for receiving the first signal and for providing a filter output signal at least partly in response to said received first signal,
a delay element in a signal path of the second signal, said delay element providing a delay output signal, and
a summation element for adding the filter output signal and the delay output signal in order to prepare the second signal for digital transmission.

2. An echo canceller according to claim 1, further comprising a decision element for deciding upon update of filter coefficients of the adaptive filter.

3. An echo canceller according to claim 2, wherein the adaptive filter comprises a FIR filter.

4. An echo canceller according to claim 2, wherein the adaptive filter comprises an element for updating filter coefficients in response to an LMS error signal.

5. An echo canceller according to claim 2, wherein the adaptive filter comprises a detector for detecting that part of the first signal comprising information for updating filter coefficients.

6. An echo canceller according to claim 5, wherein the detector comprises a double-talk detector.

7. An echo canceller according to claim 6, wherein a double-talk detection threshold of the double-talk detector is controlled by a dynamic control element.

8. An echo canceller according to claim 7, wherein the dynamic control element comprises an element for controlling the double-talk detection threshold in response to a predetermined size of an LMS error signal.

9. An echo canceller according to claim 3, further comprising an element for calculating a first level of the first signal and a second level of the second signal.

10. An echo canceller according to claim 9, wherein the decision element is adapted to decide upon filter update in response to a ratio between said first and second levels.

11. An echo canceller according to claim 2, further comprising a wide-band signal filter adapted to filter the first signal and to provide the wide-band signal filtered first signal to the decision element so as to allow filter coefficient update upon the wide-band signal filtered first signal exceeding a predetermined level.

12. An echo canceller according to claim 2, further comprising an element for calculating a filter update factor in response to a level of the first signal.

13. An echo canceller according to claim 2, further comprising a ratio control unit adapted to calculate a difference between a level of the delay output signal and a level of the output signal from the summation element and to provide said difference to the decision element.

14. An echo canceller according to claim 2, wherein the echo canceller is implemented in a DSP.

15. An echo canceller according to claim 1, wherein said digital transmission is a wireless digital transmission.

16. A signal processing circuit comprising
a codec part adapted for connection to an associated modem,
an echo canceller according to claim 1, and
a digital interface adapted for transmission of digital signals.

17. A Telephone Line Extender system adapted for connection of an associated modem to an associated analog telephone plug, the system comprising
a Portable Part adapted for connection to an the associated modem, and
a Fixed Part adapted for connection to an the associated analog telephone plug,
wherein the Portable Part and the Fixed Part comprise an element for exchange of data, and wherein said element comprises an echo canceller according to claim 1.

18. A Telephone Line Extender system according to claim 17, wherein Codec parts of the Portable Part and the Fixed Part are adapted to operate at a sample frequency of at least 8 kHz.

19. A Telephone Line Extender System according to claim 17, further comprising a modem cheating element adapted to manipulate signals in a negotiation with the associated modem.

20. A Telephone Line Extender System according to claim 19, wherein the modem cheating element is adapted to manipulate signals in phase 2 of the negotiation with the associated modem.

21. A Telephone Line Extender System according to claim 20, wherein the modem cheating element is adapted to manipulate at least one of signals A and B with respect to their timing.

22. A Telephone Line Extender System according to claim 20, wherein the Telephone Line Extender system transmits an inverted version of signal B a predetermined period after an inversion of signal A is present in the Fixed Part.

23. A Telephone Line Extender System according to claim 20, wherein the Telephone Line Extender System transmits an inverted version of signal A a predetermined period after an inversion of signal B is present in the Fixed Part.

24. A Telephone Line Extender System according to any of claims 17, wherein the Portable Part and the Fixed Part comprise an element for wireless exchange of data.

25. A Telephone Line Extender product comprising a Portable Part integrated with a modem, wherein the Portable Part is adapted for digital communication with an associated Fixed Part connected to an analog telephone plug.

26. A Telephone Line Extender product according to claim 25, wherein the digital communication is a wireless digital communication.

27. A pay-per-view settop box comprising a Telephone Line Extender product according to claim 26.
